(19) United States
(12) Patent Application Publication
(10) Pub. No.: US 2007/0062776 A1
(43) Pub. Date: Mar. 22, 2007

(54) Torque-controlling mechanism for transmission shaft

(76) Inventor: Hsin-Chi Chen, Taiping City (TW)

Correspondence Address: TROXELL LAW OFFICE PLLC;SUITE 1404, 5205 LEESBURG PIKE, FALLS CHURCH, VA, 22041, US

(21) Appl. No.: 11/357,156

(22) Filed: Feb. 21, 2006

(30) Foreign Application Priority Data
Sep. 19, 2005 (TW) 094216114

(51) Int. Cl. F16D 7/10

(52) U.S. Cl. 192/56.1; 464/35

(57) ABSTRACT

A torque-controlling mechanism for transmission shaft, including: a first shaft; a second shaft coaxially connected with the first shaft, the first and second shafts being synchronously or independently rotatable about the same axis; and a controlling unit arranged between adjacent first ends of the first and second shafts. The controlling unit includes a clutch section movable between a clutching position and a declutching position. In the clutching position, the adjacent first ends of the first and second shafts are engaged with each other via the clutch section, whereby the first and second shafts can synchronously rotate about the same axis. In the declutching position, the first and second shafts are independently rotatable about the same axis. The locating section serves to resiliently keep the clutch section in the clutching position. The clutch section includes several concaves formed on a circumference of a first end of the second shaft. Several engaging balls are respectively partially inlaid in the corresponding concaves. Several capacity-changeable receiving spaces are defined at the first end of the first shaft to respectively communicate with the concaves.

### BACKGROUND OF THE INVENTION

The present invention is related to a power tool, and more particularly to a torque-controlling mechanism for transmission shaft.

FIGS. 1 and 2 show a conventional torque-controlling mechanism for controlling or changing the output torque of a transmission shaft 1. Two ratchet wheels 2, 3 are coaxially oppositely resiliently engaged with each other. Within a tolerable range of resilient force, the springs enable the transmission shaft to transmit power. Outside the tolerable range of the springs, the ratchet wheels 2, 3 are disengaged so as to avoid excessive output and protect the work piece.

The racket wheels 2, 3 are moved along the axis of the transmission shaft 1 between the engaged position and disengaged position. This leads to inconvenience in use. In general, one end of the transmission shaft 1 is connected with a power source, while the other end of the transmission shaft 1 is coupled with a work piece. Therefore, the power source and the work piece are generally spaced by a certain distance. Under such circumstance, it is not optimal for the torque-controlling mechanism to axially move. This is because intermittent reciprocal vibration will take place in use of such torque-controlling mechanism. The reciprocal vibration may result in damage of parts and threaten the safety of an operator.

### SUMMARY OF THE INVENTION

It is therefore a primary object of the present invention to provide a torque-controlling mechanism for transmission shaft, which is able to restrict the output torque within a certain range in condition of smooth operation.

It is a further object of the present invention to provide the above torque-controlling mechanism for the transmission shaft, which is especially applicable to pneumatic tool and power tool.

According to the above objects, the torque-controlling mechanism for transmission shaft of the present invention includes: a first shaft; a second shaft coaxially connected with the first shaft, the first and second shafts being synchronously or independently rotatable about the same axis; and a controlling unit arranged between adjacent first ends of the first and second shafts. The controlling unit includes a clutch section movable between a clutching position and a declutching position. In the clutching position, the adjacent first ends of the first and second shafts are engaged with each other via the clutch section, whereby the first and second shafts can synchronously rotate about the same axis. In the declutching position, the first and second shafts are independently rotatable about the same axis. The locating section serve position. The clutch section includes several concaves formed on a circumference of a first end of the second shaft. Several engaging balls are respectively partially inlaid in the corresponding concaves. Several capacity-changeable receiving spaces are defined at the first end of the first shaft to respectively communicate with the concaves.

The engaging balls are also partially received in the receiving spaces, whereby the inner diameters of the receiving spaces can be enlarged to be at least equal to the outer diameters of the engaging balls. When the inner diameters of the receiving spaces are smaller than the outer diameters of the engaging balls, the engaging balls are engaged between the first ends of the first and second shafts and the clutch section is positioned in the clutching position. When the inner diameters of the receiving spaces are enlarged to be equal to the outer diameters of the engaging balls, the engaging balls are receivable in the receiving spaces and disengaged from the concaves and the clutch section is positioned in the declutching position.

The present invention can be best understood through the following description and accompanying drawings wherein:

### BRIEF DESCRIPTION OF THE DRAWINGS

FIG. 1 is a sectional assembled view of a conventional torque-controlling mechanism for transmission shaft, showing that the ratchet wheels are engaged with each other;

FIG. 2 is a sectional assembled view of the conventional torque-controlling mechanism for transmission shaft, showing that the ratchet wheels are disengaged from each other;

FIG. 3 is a perspective exploded view of a first embodiment of the present invention;

FIG. 4 is a perspective assembled view of the first embodiment of the present invention;

FIG. 5 is a sectional view taken along line A-A of FIG. 4;

FIG. 6 is a sectional view taken along line B-B of FIG. 4;

FIG. 7 is a sectional view taken along line C-C of FIG. 4;

FIG. 8 is a cross-sectional view of the first embodiment of the present invention, showing that the first shaft is driven to rotate in a first direction;

FIG. 9 is an axially sectional view of the first embodiment of the present invention, showing that the first shaft is driven to rotate in the first direction;

FIG. 10 is a cross-sectional view of the first embodiment of the present invention, showing that the first shaft is driven to rotate in a second direction;

FIG. 11 is an axially sectional view of the first embodiment of the present invention, showing that the first shaft is driven to rotate in the second direction;

FIG. 12 is a cross-sectional view of the first embodiment of the present invention, showing that the first shaft is driven to rotate in the second direction and the clutch section is positioned in the declutching position; and

FIG. 13 is an axially sectional view of the first embodiment of the present invention, showing that the first shaft is driven to rotate in the second direction and the clutch section is positioned in the declutching position.

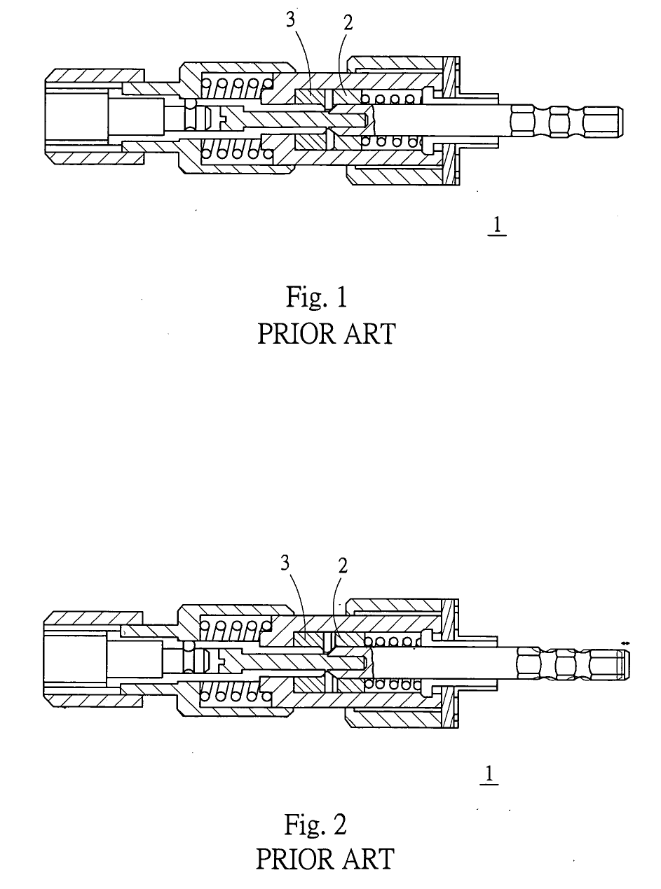

### DETAILED DESCRIPTION OF THE PREFERRED EMBODIMENTS

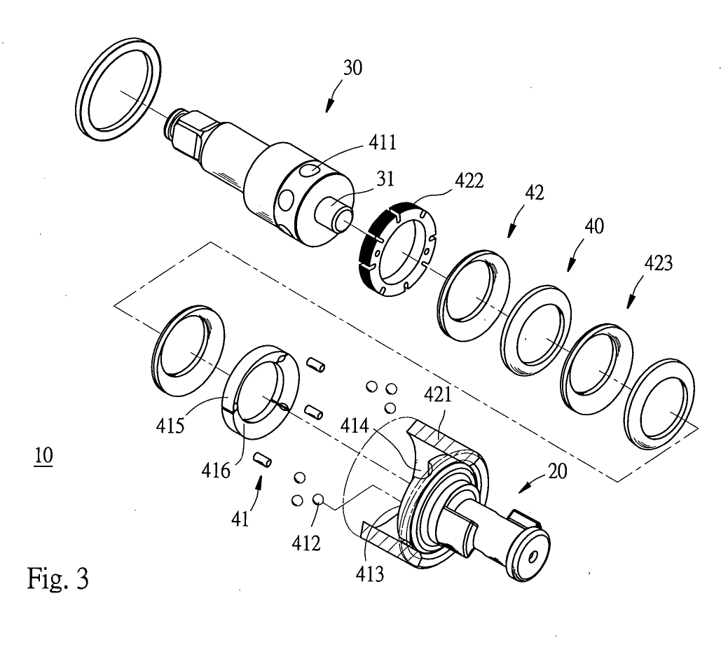

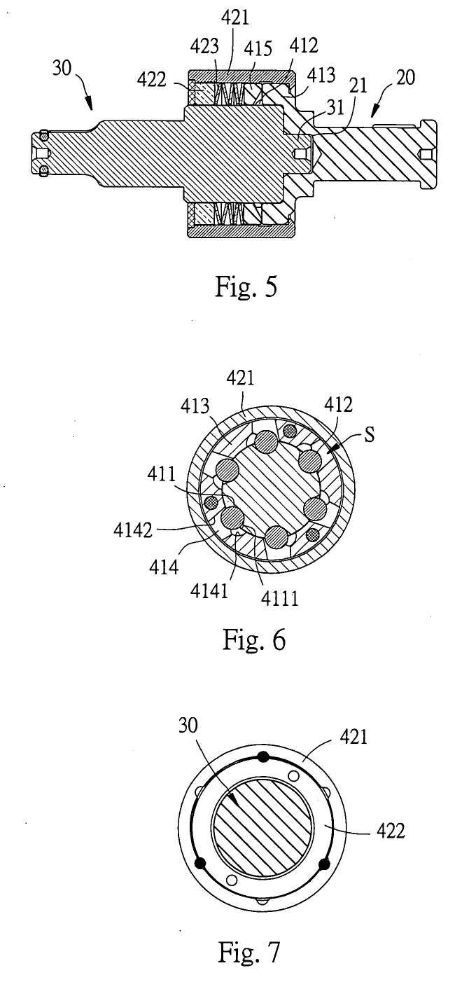

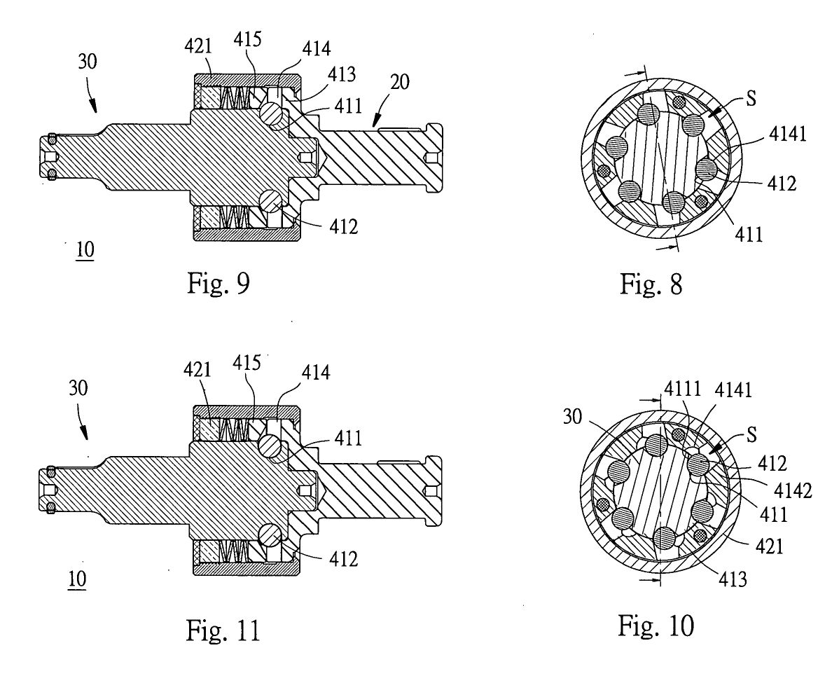

Please refer to FIGS. 3 to 8. The torque-controlling mechanism 10 for transmission shaft of the present invention includes a first shaft 20, a second shaft 30 and a controlling unit 40.

The first shaft 20 is a stem body with a certain length. A first end of the first shaft 20 is axially recessed to form a pivot hole 21.

A first end 31 of the second shaft 30 is coaxially pivotally connected in the pivot hole 21 of the first shaft 20. The first and second shafts 20, 30 can synchronously or independently rotate about the same axis.

The controlling unit 40 is arranged between the pivoted ends of the first and second shafts 20, 30 for controlling whether the first and second shafts 20, 30 synchronously rotate. The controlling unit 40 includes a clutch section 41 and a locating section 42.

The clutch section 41 includes several concaves 411 with a certain depth. The concaves 411 are formed on the circumference of the first end of the second shaft 30 at equal intervals. Each concave 411 has an opening the direction of which is perpendicular to the axis of the second shaft 30. Several engaging balls 412 are respectively partially inlaid in the corresponding concaves 411. The curvature of the concaves 411 is equal to the curvature of the engaging balls 412. A first end of a collar 413 is coaxially fixedly connected with the first end of the first shaft 20. The inner circumference of the collar 413 attaches to and abuts against the circumference of the first end of the second shaft 30. A second end of the collar 413 is positioned in the position of the openings of the concaves 411. Several arc notches 414 are formed on the second end of the collar 413 and respectively communicate with the corresponding concaves 411. A press ring 415 is coaxially movably fitted on the second shaft 30. A first end of the press ring 415 has a tapered press face 416 facing the second end of the collar 413. Several receiving spaces S are defined between the notches 414 and the press face 416. The inner diameter of the receiving space S is changeable by means of axially moving the press ring 415.

Each notch 414 has a first sidewall and a second sidewall having different curvatures respectively corresponding to the rotational directions of the first and second shafts 20, 30. The first sidewall has a curvature equal to the curvature of the engaging ball 412 and serves as a first direction stop face 4141. The second sidewall has a curvature smaller than the curvature of the engaging ball 412 and serves as a second direction stop face 4142. One side of the concave 411 is formed with an escape wall 4111 corresponding to the first direction stop face 4141. The escape wall 4111 has a curvature smaller than the curvature of the engaging ball 412.

The locating section 42 includes a bush 421 coaxially fitted on the collar 413 and the press ring 415. A first end of the bush 421 is formed with an inner flange for enclosing the first end of the collar 413. A stop ring 422 is coaxially fitted on the second shaft 30. The circumference of the stop ring 422 is screwed with the inner circumference of a second end of the bush 421. A resilient body 423 composed of several resilient gaskets is sandwiched between the stop ring 422 and the second end of the press ring 415.

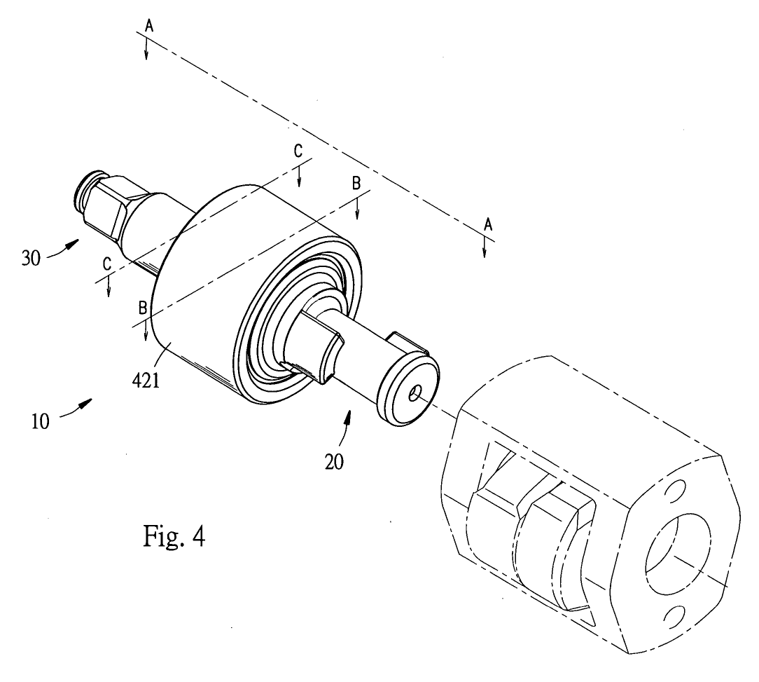

Referring to FIG. 9, when the torque-controlling mechanism 10 is driven by an external power supply (such as the conventional twin-hammer driving mechanism as shown in FIG. 4) and the first shaft 20 is rotated in a first direction, the engaging balls 412 are partially inlaid in the concaves 411 and partially inlaid in the first direction stop faces 4141. Under such circumstance, the engaging balls 412 are firmly engaged between the second shaft 30, the collar 413 and the press ring 415. Accordingly, the rotational power of the first shaft 20 can be transmitted via the controlling unit 40 to the second shaft 30. At this time, the first and second shafts 20, 30 are synchronously rotated in the first direction.

Referring to FIGS. 10 and 11, when the first shaft 20 is driven by the external power supply to rotate in a second direction, the collar 413 is driven and the first direction stop faces 4141 are disengaged from the engaging balls 412. Instead, the second direction stop faces 4142 abut against the engaging balls 412. Under such circumstance, the engaging balls 412 are pressed by the locating section 42 and resiliently located. Accordingly, the engaging balls 412 are kept bridged between the collar 413 and the concaves 411. Therefore, the power of the first shaft 20 rotating in the second direction can be transmitted to the second shaft 30. At this time, the first and second shafts 20, 30 are synchronously rotated in the second direction.

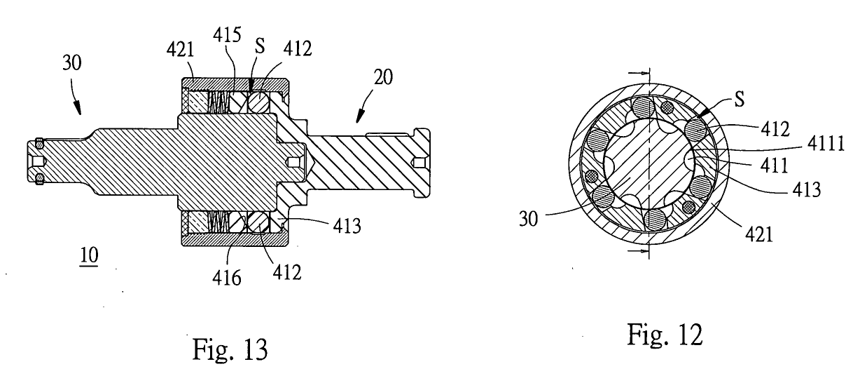

Referring to FIGS. 12 and 13, in the second rotational direction, in the case that the torque applied by the external power supply exceeds the bearable limit of the resilient body 423, the original state that the press ring 415 presses and locates the engaging balls 412 is changed. In other words, the engaging balls 412 will outward displace along the escape walls 4111 in a direction normal to the axis of the first and second shafts 20, 30 into the receiving space S. During the displacement, the press ring 415 is laterally pushed to synchronously enlarge the inner diameter of the receiving space S until the engaging balls 412 totally move out of the concaves 411. Under such circumstance, when the first shaft 20 rotates in the second direction, the second shaft 30 cannot be synchronously driven.

In conclusion, in the first and second rotational directions, the torque-controlling mechanism 10 achieves different torque-controlling effect. Substantially, in the first rotational direction, it is unnecessary for the engaging balls 412 to be located by the locating section 42. Therefore, the external power can be completely transmitted from the first shaft 20 to the second shaft 30. With pneumatic tool or power tool exemplified, such full torque output structure is usable for unscrewing operation.

When the torque-controlling mechanism 10 is rotated in the second rotational direction, in the case that the torque applied by the external power supply to the torque-controlling mechanism 10 is too great, the engaging balls 412 will be forcedly outward displaced to interrupt the transmission between the first and second shafts 20, 30. Accordingly, the too great torque is prevented from being output from the second shaft 30. With pneumatic tool or power tool exemplified, such torque-controlling structure is applicable to wrenching or screwing operation. Therefore, the parts are protected from being damaged due to excessively great torque. Also, in the assembling procedure, only a certain range of torque is applied to the screw members so as to ensure working quality.

It should be noted that in the torque-controlling mechanism 10 of the present invention, the resilient force of the locating section 42 is provided by the resilient gaskets. Therefore, by means of changing the thickness of the gaskets, the bearable torque value can be adjusted. Alternatively, by means of changing the distance between the stop ring 422 and the press ring 415, the compression stress applied to the gaskets is variable so as to achieve different bearable torque value as necessary.

The above embodiments are only used to illustrate the present invention, not intended to limit the scope thereof. Many modifications of the above embodiments can be made without departing from the spirit of the present invention.

What is claimed is:

1. A torque-controlling mechanism for transmission shaft, comprising:
a first shaft;
a second shaft coaxially connected with the first shaft, the first and second shafts being synchronously or independently rotatable about the same axis; and
a controlling unit arranged between adjacent first ends of the first and second shafts, the controlling unit including a clutch section and a locating section, the clutch section being movable between a clutching position and a declutching position, in the clutching position, the adjacent first ends of the first and second shafts being engaged with each other via the clutch section, whereby the first and second shafts can synchronously rotate about the same axis, in the declutching position, the first and second shafts being independently rotatable about the same axis, the locating section serving to resiliently keep the clutch section in the clutching position, said torque-controlling mechanism being characterized in that the clutch section includes several concaves with a certain depth, the concaves being formed on a circumference of a first end of the second shaft, several engaging balls being respectively partially inlaid in the corresponding concaves, several receiving spaces being defined at the first end of the first shaft to respectively communicate with the concaves, inner diameters of the receiving spaces being changeable, the engaging balls being also partially received in the receiving spaces, whereby the inner diameters of the receiving spaces can be enlarged to be at least equal to the outer diameters of the engaging balls, when the inner diameters of the receiving spaces are smaller than the outer diameters of the engaging balls, the engaging balls being engaged between the first ends of the first and second shafts and the clutch section being positioned in the clutching position, when the inner diameters of the receiving spaces are enlarged to be equal to the outer diameters of the engaging balls, the engaging balls being receivable in the receiving spaces and disengaged from the concaves and the clutch section being positioned in the declutching position.

2. The torque-controlling mechanism for the transmission shaft as claimed in claim 1, wherein the clutch section includes a collar, a first end of the collar being coaxially fixedly connected with the first end of the first shaft, a second end of the collar being positioned in the position of the openings of the concaves, a press ring being coaxially movably fitted on the second shaft, a first end of the press ring having a tapered press face facing the second end of the collar, the receiving spaces being defined between the second end of the collar and the press face, the distance between the press face and the second end of the collar being changeable by means of moving the press ring along the axis of the second shaft so as to change the inner diameters of the receiving spaces.

3. The torque-controlling mechanism for the transmission shaft as claimed in claim 2, wherein the clutch section has several pairs of first and second direction stop faces, each pair of first and second direction stop faces being respectively formed on two sides of a receiving space corresponding to a first rotational direction and a second rotational direction of the first and second shafts.

4. The torque-controlling mechanism for the transmission shaft as claimed in claim 3, wherein the first direction stop face is an arc face with a curvature equal to the curvature of the engaging ball.

5. The torque-controlling mechanism for the transmission shaft as claimed in claim 3, wherein the second direction stop face is an arc face with a curvature smaller than the curvature of the engaging ball.

6. The torque-controlling mechanism for the transmission shaft as claimed in claim 3, wherein one side of the concave is formed with an escape wall corresponding to the first direction stop face, the escape wall having a curvature smaller than the curvature of the engaging ball.

7. The torque-controlling mechanism for the transmission shaft as claimed in claim 2, wherein the locating section includes a bush coaxially fitted on the collar and the press ring, a first end of the bush being formed with an inner flange for enclosing the first end of the collar, a stop ring being coaxially fitted between the second shaft and a second end of the bush, at least one resilient body being sandwiched between the stop ring and the second end of the press ring.

8. The torque-controlling mechanism for the transmission shaft as claimed in claim 7, wherein the resilient body is a gasket.

9. The torque-controlling mechanism for the transmission shaft as claimed in claim 7, wherein the stop ring is screwed with the bush.

10. The torque-controlling mechanism for the transmission shaft as claimed in claim 1, wherein the curvature of the concave is equal to the curvature of the engaging ball.
